(19) United States
(12) Patent Application Publication
(10) Pub. No.: US 2026/0289529 A1
(43) Pub. Date: Sep. 24, 2026

(54) METHOD FOR EXCHANGING ENGAGEMENT ON A SOCIAL MEDIA NETWORK

(71) Applicant: Tiago Miguel BALSA SARAIVA, Moscavide (PT)

(72) Inventor: Tiago Miguel BALSA SARAIVA, Moscavide (PT)

(21) Appl. No.: 19/472,718

(22) PCT Filed: Mar. 15, 2024
(86) PCT No.: PCT/IB2024/052527

§ 371 Date: Oct. 6, 2025

(30) Foreign Application Priority Data
Apr. 6, 2023 (PT) 118595

(51) Int. Cl. G06Q 10/40; G06Q 30/0282; H04L 67/306

(52) U.S. Cl. CPC G06Q 10/40; G06Q 30/0282; H04L 67/306

(57) ABSTRACT

The present application relates to a method for exchanging engagement on a social media network that comprises an ordered sequence of steps (i., ii., iii., iv., v.), comprising receiving an engagement request (i.), validating said engagement request (ii.), providing a link for the content item subject to the engagement action only to validated users (iii., iv.) and checking if the engagement action is performed (v.). In a preferred aspect, the method implements a reward mechanism that ensures balance between all user profiles when it comes to requesting and giving engagement, which favours transparency and fairness among all of them when accessing engagement actions.

### FIELD OF THE APPLICATION

The present application relates generally to social media networking. More particularly, it relates to methods and systems for exchanging engagement over a social media network.

### PRIOR ART

One of the most effective channels of disseminating and obtaining information is through direct, personal relationships referred to as social media networks. A social media network consists of individuals and their personal relationships to other individuals through which social information and opportunities are exchanged.

Computer-based social media networks such as Facebook, Twitter, Instagram or LinkedIn, provide opportunities for individuals (users) to maintain, nurture, and develop relationships with other users. These networks typically enable users to view user profiles of other users, and to link with other users with whom a pre-existing actual relationship exists or with whom an actual social or business relationship is desired.

Typically, once linked together through a computer-based social media network, users can exchange social media content items such as communications, photographs, or other media content. In particular, social media networks allow its users to communicate more efficiently content items allowing then to receive social media engagement. This term relates to actions that reflect how much a target audience (the other users of a social media network) interacts with a content item shared by a user. Said actions may vary according to the social media network, but generally includes feedback input in the form of a click or an alphanumeric text.

In fact, engagement is one of the most important metrics for managing social media networks since it allows to measure how a social media content item is resonating with a target audience. And this metric is extremely relevant, for example, in the marketing sector, which uses social media networks to communicate new brands or products and who therefore need to obtain this data reliably and as accurately as possible, in order to be able to adapt and improve the communication strategies used in social media networks in view of the dynamics that characterize such digital environment.

However, automatic engagement by fake users or potentially harmful profiles is a growing phenomenon that has a very negative impact on the functioning of social media networks, especially in terms of user effort rate that is, the volume and quality of interactions that a user receive for shared social media content items. As a result, engagement metrics may be contaminated, which prevents obtaining real metrics on how audiences are interacting with a content item. Moreover, automatic engagement may also contribute to the spread of misinformation, which results in degradation of online communities.

The present solution intends to innovatively overcome such issues.

### SUMMARY OF THE APPLICATION

It is therefore an object of the present application a method for exchanging engagement on a social media network.

By avoiding automated engagement, among other advantages, the method now developed ensures that a social media network operates in a manner that is transparent and fair to all users, in terms of user effort rate, preventing spreading misinformation and consequently, the degradation of online communities.

In an advantageous configuration of the method of the present application, it comprises the following steps:
receiving, from a user of at least one social media network, an engagement request; said engagement request including at least one link to a social media content item to receive engagement, said social media content item being associated with at least one social media network user profile related to said user;
executing a user profile assessment including querying a user profiles database containing an updated list of approved user profiles, in order to verify if a user profile associated to the social media content item to receive engagement is contained in the list; and validating a user profile if said user profile is contained in the list of approved user profiles;
performing a link quality assessment to refuse or to approve the social media content item to receive engagement;
validating the engagement request if the respective social media content is approved and if it is associated with at least one validated user profile;
feeding an exchange pool with a link included in a valid engagement request;
providing a link from the exchange pool to at least one user profile related to a user intending to perform an engagement action; said at least one user profile being contained in the list of approved user profiles of the user profiles database;
checking if the engagement action is performed by said at least one user profile.

The method therefore provides a better mode of ensuring that the engagement that is exchanged on a social media network is of high quality and that the social media network is secure and free from scams. In the context of the present application, a high quality engagement reflects an actual interaction between at least two validated user profiles, one requesting engagement and the other giving engagement on a content item that meets the requirements to be subject to engagement.

It is also an object of the present application a system for exchanging engagement on a social media network.

In an advantageous configuration of the system, it is comprised by:
one or more social media network databases; the one or more social media network databases describing one or more social media network that define user profiles connected by relationships in a network;
at least one processor configured to implement the method for exchanging engagement on a social media network, also described in the present application.

### DESCRIPTION OF FIGURES

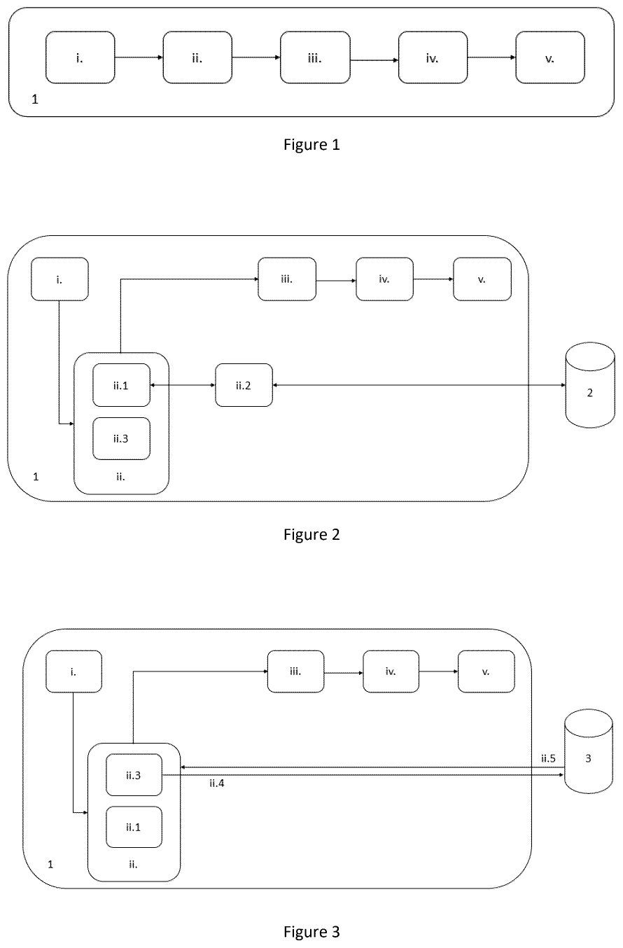

FIG. 1 illustrates a schematic representation of the steps that make up the method for exchanging engagement on a social media network described in the present application. The reference signs represent
i.—receiving an engagement request;
ii.—engagement request validation;
iii.—feeding exchange pool with valid engagement requests;
iv.—providing a link from the exchange pool to a user profile;
v.—checking if an engagement action is performed.
1—processor configured to implement the method steps i. to v.

FIG. 2 illustrates a flow diagram related to the engagement request validation process. The reference signs represent:
i.—receiving an engagement request;
ii. engagement request validation;
ii.1.—executing a user profile assessment
ii.2—querying a user profiles database;
ii.3—executing a link quality assessment;
iii.—feeding exchange pool with valid engagement requests;
iv.—providing a link from the exchange pool to a user profile;
v.—checking if an engagement action is performed.
1—processor configured to implement the method steps i. to v.
2—user profiles database.

FIG. 3 illustrates a flow diagram of an embodiment of the method described in the present application, wherein the reference signs represent:
i.—receiving an engagement request;
ii. engagement request validation;
ii.1—executing a user profile assessment
ii.3—executing a link quality assessment;
ii.4—storing links to approved social media contents in a link-database;
ii.5—selecting links from the database with an active status assigned;
iii.—feeding exchange pool with links having an active status assigned;
1—processor configured to implement the method steps i. to v.;
3—link-database.

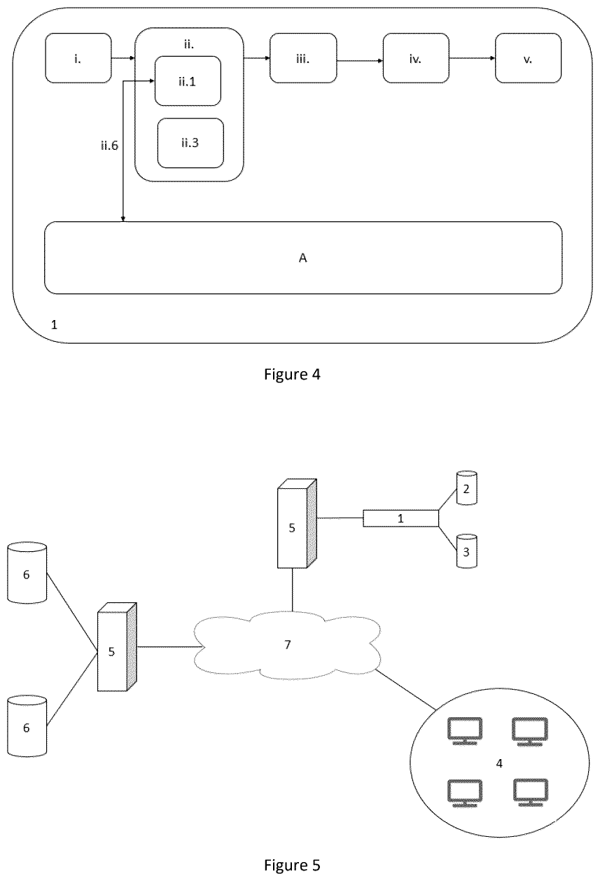

FIG. 4 illustrates a flow diagram of an embodiment of the method described in the present application which implements a reward mechanism for controlling the engagement exchange between user profiles of a social media network. The reference signs represent:
i.—receiving an engagement request;
ii. engagement request validation;
ii.1.—executing a user profile assessment
ii.3—executing a link quality assessment;
ii.6—ascertaining the number of points of each user submitting an engagement request;
iii.—feeding exchange pool with links having an active status assigned;
iv.—providing a link from the exchange pool to a user profile;
v.—checking if an engagement action is performed.
1—processor configured to implement the method steps i. to v.;
A—reward mechanism.

FIG. 5 illustrates an embodiment of the system for exchanging engagement on a social media network. The reference signs represent:
1—processor configured to implement the method steps i. to v.;
2—user profiles database;
3—link-database;
4—user computers;
5—server;
6—social media network database;
7—network.

### DETAILED DESCRIPTION

The more general and advantageous configurations of the objects of present application are described in the Summary. Such configurations are detailed below in accordance with other advantageous and/or preferred embodiments of implementation of said objects.

A first object of the present application relates to a method for exchanging engagement on a social media network.

In the context of the present application, a user of a social media network is an individual that has associated at least one user profile. A user profile is, then, used to represent a user in a specific social media network, being a collection of settings and information associated with him/her, such as age, gender, portrait photograph or other individual characteristics like knowledge or expertise. A user profile has a respective page profile where such information is displayed and where other type of social data, related with social media content items that were shared using said profile with the social media network, are recorded.

Also in the context of the present application, a social media content item is a content that a user profile shares on the social media network. Said content may relate to a text update, a photo, graphic or a video, and is associated to a link to a resource, such a website, where said content item can be accessed via the link.

With these definitions in mind, an engagement exchange and an engagement action represent interactions on social media content items that are shared on a social media network, between two or more users, each one being represented by the respective user profiles. Such interactions are realized through social media content actions that can be in the form of a feedback input provided by users of the social media network, through the respective user profiles, and may vary depending on the social media network specificities.

The concept of engagement exchange presupposes that there is a certain logic and rationality associated with the process of requesting and providing engagement on a social media content item being shared, with a view to facilitating engagement exchange between user profiles without compromising the operation of the social media network in terms of transparency and fairness to its users (in terms of user effort rate).

The implementation of this method may resort to APIs (application programming interface) to integrate with various social media networks. These APIs provide access to key features and data of the social media networks, such as user profiles, engagement actions, and content creation tools, which are processed according to the embodiments that will be described later.

In a preferred embodiment of the method for exchanging engagement on a social media network of the present application, it comprises an ordered sequence of steps, as illustrated in FIG. 1, to be implemented by one or more processors (1).

In a first step (i.) an engagement request issued by a user of at least one social media network is received. The engagement request may include at least one link to a social media content item to receive engagement, said social media content item being associated with at least one profile related to user requesting engagement.

In a second step (ii.) of the method, the engagement request received is subject to a validation process, illustrated in FIG. 2. Said process may include performing a user profile assessment (ii.1) and a link quality assessment (ii.3).

More particularly, the user profile assessment may include querying (ii.2) a user profiles database (2) containing an updated list of approved user profiles, in order to verify if a user profile associated to the social media content item to receive engagement is contained in the list. If said user profile is contained in the list of approved user profiles, the user profile is validated.

In its turn, the link quality assessment (ii.3) is executed to refuse or to approve the social media content item to receive engagement, in order to prevent unformatted or non-standard content as well as abusive content from shared on the social media network. This further stage of assessment involves checking the compliance of a link with a set of established requirements, that may relate to the type and format of the social media content associated with the link, the type of engagement to be requested and the social media network where said engagement is to be performed.

An engagement request may be then validated if the respective social media content is approved and if it is associated with at least one validated user profile. Otherwise, the engagement request is rejected and no engagement action is performed.

A third step of the method (iii.) involves feeding an exchange pool with a link included in a valid engagement request.

In a fourth step of the method (iv.) a link from the exchange pool is provided to at least one user profile related to a user intending to perform an engagement action. Said user profile corresponds to a valid user profile that is contained in the list of approved user profiles of the user profiles database (2). In this way, it is guaranteed that the engagement exchange is carried out between users recognized and validated by the method, ensuring engagement being exchanged is of high quality.

Consequently, one of the advantages that this method allows is to create a controlled ecosystem of user profiles that intend to give and receive engagement, thus ensuring that the content items and user profiles involved in an engagement action comply with the established requirements.

Finally, the fifth step of the method (v.) relates checking if the engagement action is performed by said at least one user profile.

In one embodiment of the method, the step of executing a user profile assessment includes:
receiving a user profile related to a user of a social media network intending to receive engagement;
executing a first-tier multi-stage control process including checking the user profile for compliance with a set of pre-requirements and confirming user profile ownership; and
adding the user profile to the list of approved user profiles if the user profile complies with the set of pre-requirements and its profile ownership is confirmed.

In another embodiment of the method, it further comprises the step of updating the exchange pool with a link included in a valid engagement request.

In another embodiment of the method, as illustrated by FIG. 3, it further includes the steps of:
storing (ii.4) links to approved social media contents in a link-database (3);
assigning an active, a pending or a cancelled status to each link of the link-database; and
feeding the exchange pool with links selected (ii.5) from the link-database (3) which have an active status assigned.

More particularly, in another embodiment, the method may comprise assigning a pending status to a link stored in the link-database (3), which relates to a social media content item associated with a user profile that is not contained in the list of approved user profiles of the user profiles database (2). In this case, the user profile assessment (ii.1) is executed periodically, in order to verify if the user profile is contained in the list of approved users. Once that happens, the status of the link may be changed from pending to active, in order to validate the engagement request (ii.).

Additionally, in another embodiment, the method may also include the step of periodically monitoring the active links of the link-database (3) in order to be able to change the status of each link from active to cancelled if the respective social media content item relates to an obsolete social media content item, that is, a content item that is no longer available for engagement or that has not received a predetermined number of engagement hits during a predetermined period of time.

In another embodiment of the method, prior to providing a link from the exchange pool to at least one user profile related to a user intending to perform an engagement action (iv.), the method may further include:
executing a second-tier multi-stage control process, including checking the user profile for compliance with a set of pre-requirements and confirming user profile ownership;
maintaining the user profile in the list of approved user profiles of the user profiles database (2) if the user profile complies with the set of pre-requirements and its profile ownership is confirmed; or remove the user profile from the list of approved user profiles of the user profiles database (2) if at least one of the pre-requirements is not complied or the profile ownership is not confirmed.

This second control step is intended to monitor user profiles previously approved in the first control step, ensuring that engagement is only carried out with user profiles that maintain compliance with all the requirements that lead to the validation of a user profile. In other words, it allows to confirm whether a user profile that was validated in the first control stage, typically in the context of requesting an engagement, still complies with the requirements to enable him/her to interact with the social media network again, for the purpose of requesting or providing engagement. In this way, it is guaranteed that engagement being exchanged between user profiles is of high quality, since any interaction with the social network is preceded by a user validation step.

More particularly, the first-tier and the second-tier multi-stage control process are implemented using user profile data extractable from a social media network database (6), and wherein the user profile pre-requirements to be checked are at least one or a combination of the following:
public type profile:
   The user profile must be a public profile, allowing other user profiles of the social media network to view the user profile page and to access to shared social media content items. On the other hand, user profiles that are private do not allow access to his/her social data, so such type of user profile cannot be validated. Consequently, an engagement request made by a private user profile will be rejected.
profile date of creation, number of social media content items associated to a user profile and/or user profile ratio between followers and following:
   It allows to detect fake or potentially harmful user profiles that are created specifically for the purpose of requesting or giving engagement, which could be a sign of an abusive behaviour from a user of a social media network. This has a negative impact on the quality of the engagement that is generated, in addition to not favouring transparency and fairness among all users (in terms of user effort rate) of the social media network.
detection of humanized social media content actions associated to the user profile:
   Allows detecting social media content actions that are performed by autonomous programs (typically known as bots), thereby allowing to exclude user profiles controlled by such bots and to eliminate automated engagement.

Regarding the user profile ownership confirmation that is executed both in the first-tier and in the second-tier multi-stage control process, such process may comprise the following steps:
requesting the user related to a user profile whose ownership is to be tested, to perform a predefined ownership action in a social media network;
checking whether said predefined ownership action is performed by the user, by checking user profile data;
confirming user profile ownership if the ownership action is performed by the user.

More particularly, an ownership action may relate to one or a combination of the following social media content actions: interactions with a specific social media content item and/or configuration of specific user profile bio information. A user interaction may be executed through a feedback input on a social media content item, said feedback input being a click, a text comprised by alphanumeric or non-alphanumeric characters and/or an image or a video file. In its turn, configuring user profile bio information may relate to adding a predefined code or hashtag to said profile bio information.

In another embodiment of the method, an engagement request may further include engagement metrics. One of such metrics may relate to the type of social media content action that is requested to perform the engagement action, that is, whether the feedback input to be given is through a click, a text and/or any other type of feedback input allowed by the social media network.

Another engagement metric that may be configured relates to a target group of social media user profiles for which the content item subject of the engagement is to be directed. This metric allows to limit engagement to a particular group of user profiles, that share interest related to a content item.

The number of engagement hits to be achieved in an engagement action may also be configured as an engagement metric. This metric allows to maintain the engagement action available for all validated users while this metric is not achieved.

In another embodiment of the method, the exchange pool implements a control logic to organize the links to be provided to user profiles related to users intending to perform an engagement action. Said control logic is used to prioritize the links according to a predetermined priority rule, such a FIFO logic.

Alternatively, the priority rule may be based on a set of engagement metrics. More particularly, the priority rule may be based on the number and/or user social media content actions, such as user interactions with a specific social media content item through a feedback input on a social media content item. As mentioned before, a feedback input may be concretized through a click, a text comprised by alphanumeric or non-alphanumeric characters and/or an image or a video file.

In a preferred aspect of the method of the present application, it further comprises the step of implementing an engagement reward mechanism (A).

Said reward mechanism (A) may comprise the following steps:
generating a predetermined number of engagement points to be distributed and assigned to each user with at least one related user profile contained in the list of approved user profiles of the user profiles database;
suppressing a predetermined number of points to a user for each engagement requested;
rewarding a user with a predetermined number of points for each engagement action performed.

Through this reward mechanism (A), balance is ensured between all user profiles when it comes to requesting and giving engagement, which favours transparency and fairness among all of them (in terms of user effort rate) when accessing engagement actions. That is, a user profile can only participate in this ecosystem if he/she performs both actions. In the context of the reward mechanism (A), in another embodiment of the method, as illustrated in FIG. 4, the user profile assessment (ii.1) that is executed to validate a user profile requesting engagement may include:
ascertaining (ii.6) the number of points of each user submitting an engagement request (i.);
refusing the engagement request (i.), in the engagement request validation step (ii.) if the number of points assigned to the respective user is less than the predetermined number of points to be supressed to said user due to the engagement request submitted.

Consequently, for a user to be able to request engagement (i.), he/she will have to have enough points to do so, which means that, at any given time, he/she will have to also give engagement. This ensures that the engagement being exchanged is of high quality and that users are awarded points only for engagement that has been made correctly, and that the interactions with the social media network are secure and free from scams.

In connection to this, the step of the method related to check if the engagement action is performed (v.) by a user profile, may include rewarding the user related to the user profile performing the engagement action with a predetermined number of points if the engagement action is performed.

Additionally, the number of points to be suppressed to a user profile for requesting engagement may be determined according to one or a combination of the following:
type of social media content action required;
target group; and/or
number of engagement hits to be achieved.

In its turn, the number of points to reward a user for performing an engagement action may be determined according to one or a combination of the following:
type of social media content action required; and/or
target group.

More particularly, the type of social media content action may relate to at least one or a combination of the following:
a feedback input; said feedback input being a click, a text comprised by alphanumeric or non-alphanumeric characters and/or an image or a video file;
the social media content item being a video content, and the social media content action being watching the video content for at least a predefined period of time.

In another embodiment of the method, the step of providing an engagement link from the exchange pool to at least one user profile (iv.) related to a user intending to perform an engagement action may include:
analysing user profiles historical engagement data and providing the engagement link to at least one user profile according to said historical engagement data; and/or
categorizing user profiles and social media content items for which engagement is requested and providing the engagement link to the at least one user profile whose profile matches at least one category with the social media content item.

A category of a user profile or content item may be based on one or a combination of the following:
a demographic criterion; and/or
an engagement criterion, considering the number of followers, the number of followings and/or the number of social media content items associated to a user profile.

In this way it is possible to segment user profiles based on engagement history, location and other social data. This information is usefully to create reports on audience demographics, interests, and user profiles behaviour on a social media network.

In another embodiment of the method, it may further comprise the steps of:
feeding past engagement data, related to user profiles and social media content items, to a predictive analytics engine;
executing, by said predictive analytics engine, a predictive model based on at least the user profile's historical engagement data and the categories of user profiles and of social media content items; and
outputting engagement recommendations to a user intending to perform an engagement action.

The predictive analytics help users make informed decisions about their engagement strategies. For that purpose, natural language processing tools may be used to help users identify relevant content and engage in meaningful conversations with their audience. More particularly, such tools may be used to optimize the engagement process by analysing past engagement data and using that information to predict which types of engagement will be most effective for each user profile. Additionally, it allows to personalize engagement recommendations based on a user's engagement history, preferences, and interests.

The method also includes the acquisition and processing of data related to the engagement action, which allows the generation of:
performance reports for individual profiles, including engagement rate, reach and growth;
Comparison reports for multiple profiles, allowing users to see how their performance stacks up;
Analysis of engagement trends over time, highlighting changes in engagement rate or other metrics; and/or
Data visualization tools to help users understand their data and identify trends.

A second object of the present application relates to a system for exchanging engagement on a social media network.

The system may comprise:
one or more social media network databases (6), describing one or more social media network that define user profiles connected by relationships in a network (7);
a set of one or more processors (1) and databases (2, 3) configured to implement the method described in the present application.

In one embodiment of the system, as illustrated in FIG. 5, it may further comprise the following elements, that are connected through the network (7):
at least one server (5), configured to host a social media network website that is supplied by the one or more social media network databases (6); said social media network providing access to at least one social media content item;
a server (5) connected to the network (7) and configured to host the set of one or more processors (1) and databases (2, 3);
a plurality of user computers (4) connected to the network (7) and configured to interact with the social media network website by means of a user profile.

As will be clear to one skilled in the art, the present invention should not be limited to the embodiments described herein, and a number of changes are possible which remain within the scope of the present invention.

Of course, the preferred embodiments shown above are combinable, in the different possible forms, being herein avoided the repetition all such combinations.

1. A method for exchanging engagement on a social media network, comprising the following steps:
receiving (i.), from a user of at least one social media network, an engagement request; said engagement request including at least one link to a social media content item to receive engagement, said social media content item being associated with at least one social media network user profile related to said user;
executing a user profile assessment (ii.1) including querying (ii.2) a user profiles database (2) containing an updated list of approved user profiles, in order to verify if a user profile associated to the social media content item to receive engagement is contained in the list; and validating a user profile if said user profile is contained in the list of approved user profiles;
performing a link quality assessment (ii.3) to refuse or to approve the social media content item to receive engagement;
validating the engagement request (ii.) if the respective social media content is approved and if it is associated with at least one validated user profile;
feeding an exchange pool (iii.) with a link included in a valid engagement request;
providing a link from the exchange pool to at least one user profile (iv.) related to a user intending to perform an engagement action; said at least one user profile being contained in the list of approved user profiles of the user profiles database (2);
checking if the engagement action is performed (v.) by said at least one user profile.

2. The method according to claim 1, wherein executing a user profile assessment (ii.1) includes:
receiving a user profile related to a user of a social media network intending to receive engagement;
executing a first-tier multi-stage control process including checking the user profile for compliance with a set of pre-requirements and confirming user profile ownership;
adding the user profile to the list of approved user profiles if the user profile complies with the set of pre-requirements and its profile ownership is confirmed.

3. The method according to claim 1, further comprising the step of:
updating the exchange pool with a link included in a valid engagement request.

4. The method according to claim 1, further including the steps of:
storing links (ii.4) to approved social media contents in a link-database (3);
assigning an active, a pending or a cancelled status to each link of the link-database;
feeding the exchange pool with links with an active status assigned.

5. The method according to claim 4, further comprising:
assigning a pending status to a link stored in the link-database (3); said link being related to a social media content item associated with a user profile that is not contained in the list of approved user profiles of the user profiles database (2);
periodically executing the user profile assessment (ii.1) in order to verify if the user profile is contained in the list;
changing the status of the link from pending to active if said user profile is contained in the list of approved user profiles.

6. The method according to claim 4, further comprising:
periodically monitoring the active links of the link-database (3) and changing the status of a link from active to cancelled if the respective social media content item relates to an obsolete social media content item;
wherein,
an obsolete social media content item being related to a content item that is no longer available for engagement or being related to a content item that has not received a predetermined number of engagement hits during a predetermined period of time.

7. The method according to claim 1, wherein prior to providing a link from the exchange pool to at least one user profile related to a user intending to perform an engagement action, the method further includes the steps of:
executing a second-tier multi-stage control process including checking the user profile for compliance with a set of pre-requirements and confirming user profile ownership;
maintaining the user profile in the list of approved user profiles of the user profiles database (2) if the user profile complies with the set of pre-requirements and its profile ownership is confirmed; or remove the user profile from the list of approved user profiles of the user profiles database (2) if at least one of the pre-requirements is not complied or the profile ownership is not confirmed.

8. The method as in claim 2, wherein prior to providing a link from the exchange pool to at least one user profile related to a user intending to perform an engagement action, the method further includes the steps of:
executing a second-tier multi-stage control process including checking the user profile for compliance with a set of pre-requirements and confirming user profile ownership;
maintaining the user profile in the list of approved user profiles of the user profiles database (2) if the user profile complies with the set of pre-requirements and its profile ownership is confirmed; or remove the user profile from the list of approved user profiles of the user profiles database (2) if at least one of the pre-requirements is not complied or the profile ownership is not confirmed;
and—wherein,
the first-tier and the second-tier multi-stage control process are implemented using user profile data extractable from a social media network database (6), and wherein,
the user profile pre-requirements to be checked are at least one or a combination of the following:
public type profile;
profile date of creation;
detection of humanized social media content actions associated to the user profile;
user profile ratio between followers and following; and/or
number of social media content items associated to the user profile.

9. The method according to claim 1, wherein executing a user profile assessment (ii.1) includes:
receiving a user profile related to a user of a social media network intending to receive engagement;
executing a first-tier multi-stage control process including checking the user profile for compliance with a set of pre-requirements and confirming user profile ownership;
adding the user profile to the list of approved user profiles if the user profile complies with the set of pre-requirements and its profile ownership is confirmed; and wherein,
prior to providing a link from the exchange pool to at least one user profile related to a user intending to perform an engagement action, the method further includes the steps of:
executing a second-tier multi-stage control process including checking the user profile for compliance with a set of pre-requirements and confirming user profile ownership;
maintaining the user profile in the list of approved user profiles of the user profiles database (2) if the user profile complies with the set of pre-requirements and its profile ownership is confirmed; or remove the user profile from the list of approved user profiles of the user profiles database (2) if at least one of the pre-requirements is not complied or the profile ownership is not confirmed;
and wherein,
confirming user profile ownership comprises the following steps:
requesting the user related to the user profile to perform a predefined ownership action in a social media network;
checking whether said predefined ownership action is performed by the user by checking user profile data;
confirming user profile ownership if the ownership action is performed by the user.

10. The method according to claim 9, wherein a predefined ownership action relates to one or a combination of the following social media content actions: interactions with a specific social media content item and/or configuration of specific user profile bio information; optionally,
said user interaction being executed through a feedback input on a social media content item, said feedback input being a click, a text comprised by alphanumeric or non-alphanumeric characters and/or an image or a video file; and
configuring user profile bio information relates to adding a predefined code or hashtag to said profile bio information.

11. The method according to claim 1, wherein the engagement request further includes engagement metrics related to one or a combination of the following: user social media content actions requested, target groups of social media users and/or number of engagement hits to be achieved.

12. The method according to claim 1, wherein the exchange pool implements a control logic to organize the links to be provided to user profiles related to users intending to perform an engagement action;
said control logic is used to prioritize the links according to a predetermined priority rule.

13. The method according to claim 12, wherein the priority rule is based on FIFO logic.

14. The method according to claim 12, wherein the priority rule is based on a set of engagement metrics; optionally, the priority rule is based on the number and/or user social media content actions, such as user interactions with a specific social media content item through a feedback input on a social media content item;
said feedback input being a click, a text comprised by alphanumeric or non-alphanumeric characters and/or an image or a video file.

15. The method according to claim 1, further comprising implementing an engagement reward mechanism (A); said reward mechanism (A) comprising the following steps:
generating a predetermined number of engagement points to be distributed and assigned to each user with at least one related user profile contained in the list of approved user profiles of the user profiles database;
suppressing a predetermined number of points to a user for each engagement requested;
rewarding a user with a predetermined number of points for each engagement action performed.

16. The method according to claim 15, wherein the user profile assessment (ii.1) to validate a user profile for engagement further includes:
ascertaining (ii.6) the number of points of each user submitting an engagement request;
refusing the engagement request if the number of points assigned to the respective user is less than the predetermined number of points to be supressed to said user due to the engagement request submitted.

17. The method according to claim 15, wherein the step of checking if the engagement action is performed (v.) by a user profile further includes:
rewarding the user related to the user profile performing the engagement action with a predetermined number of points if the engagement action is performed.

18. The method according to claim 15, wherein the number of points to be suppressed to a profile for requesting engagement is determined according to one or a combination of the following: type of social media content action required, target group or number of engagement hits to be achieved,
and wherein,
the number of points to reward a user for performing an engagement action is determined according to one or a combination of the following: type of social media content action required and target group;
the type of social media content action being related at least one or a combination of the following:
a feedback input; said feedback input being a click, a text comprised by alphanumeric or non-alphanumeric characters and/or an image or a video file;
the social media content item being a video content, and the social media content action being watching the video content for at least a predefined period of time.

19. The method according to claim 1, wherein the step of providing an engagement link from the exchange pool (iv.) to at least one user profile related to a user intending to perform an engagement action, includes:
analysing user profiles historical engagement data and providing the engagement link to at least one user profile according to said historical engagement data; and/or
categorizing user profiles and social media content items for which engagement is requested and providing the engagement link to the at least one user profile whose profile matches at least one category with the social media content item; said category being based on one or a combination of the following:
a demographic criterion;
an engagement criterion, considering the number of followers, the number of followings and/or the number of social media content items associated to a user profile;
optionally,
the method further comprises the steps of:
feeding past engagement data, related to user profiles and social media content items, to a predictive analytics engine;
executing, by said predictive analytics engine, a predictive model based on at least the user profile's historical engagement data and the categories of user profiles and of social media content items; and
outputting engagement recommendations to a user intending to perform an engagement action.

20. (canceled)

21. A system for exchanging engagement on a social media network, the system comprising:
one or more social media network databases (6); the one or more social media network databases (6) describing one or more social media network that define user profiles connected by relationships in a network (7);
a set of one or more processors (1) and databases (2, 3) configured to implement the method of claim 1;
optionally, the system further comprises the following elements, that are connected through the network (7):
at least one server (5), configured to host a social media network website that is supplied by the one or more social media network databases (6); said social media network providing access to at least one social media content item;
a server (5) connected to the network (7) and configured to host the set of one or more processors (1) and databases (2, 3);
a plurality of user computers (4) connected to the network (7) and configured to interact with the social media network website by means of a user profile.

22. (canceled)
